(19) United States
(12) Patent Application Publication
(10) Pub. No.: US 2012/0107681 A1
(43) Pub. Date: May 3, 2012

(54) SECONDARY BATTERY

(75) Inventor: Masanori KOGURE, Tokyo (JP)

(73) Assignee: MITSUBISHI HEAVY INDUSTRIES, LTD., Tokyo (JP)

(21) Appl. No.: 13/275,692

(22) Filed: Oct. 18, 2011

(30) Foreign Application Priority Data
Oct. 29, 2010 (JP) 2010-243899

(51) Int. Cl. H01M 2/10

(52) U.S. Cl. 429/208

(57) ABSTRACT

Provided is a secondary battery including: a battery case; a stacked body that is housed inside the battery case and includes a plurality of electrode plates; and a frame that is arranged between the stacked body and the battery case and engages a plurality of insulating plates with each other to surround the stacked body in an annular shape, wherein end surfaces of two of the insulating plates engaging with each other are respectively provided with an engaging portion or a engaged portion, and wherein the engaging portion formed in the end surface of one of the two insulating plates engages with the engaged portion of the other of the two insulating plates, so that the stacked body is surrounded in an annular shape by the insulating plates.

### BACKGROUND OF THE INVENTION

1. Field of the Invention

The present invention relates to a secondary battery.

Priority is claimed on Japanese Patent Application No. 2010-243899, filed on Oct. 29, 2010, the content of which is incorporated herein by reference.

2. Description of Related Art

A secondary battery has been used as a power source of various electrical devices or a power buffer of a power generating device. As a configuration example of the secondary battery, a lithium ion battery of a staked type disclosed in JP-A No. 2008-091099 is an exemplary example thereof.

The lithium ion battery of a stacked type disclosed in JP-A No. 2008-091099 includes a stacked body, in which a positive electrode plate and a negative electrode plate respectively formed by coating a collector with an active material, are stacked with a separator interposed between them. The stacked body is stored in a battery case. A pair of pressure sheets is provided at both sides of the stacked body. The pair of pressure sheets is adhered to a common tape. Therefore, the relative position thereof is fixed. The stacked body is pressed by the tape in the compressing direction. Therefore, a positional deviation between the positive and the negative electrodes is prevented.

However, the thickness of the electrode plate (the positive electrode plate and the negative electrode plate) is, for example, several tens of μm or so, and may be deformed or damaged due to an interference with the battery case or the like. For example, in the lithium ion battery disclosed in JP-A No. 2008-091099, adhesiveness of the tape may be degraded when the adhesive component thereof is dissolved in an electrolyte. When the adhesiveness of the tape is degraded, the relative position between the pair of pressure sheets may not be defined. Therefore, the electrode plates may move between the pair of pressure sheets. When the electrode plates move and get stuck between the pressure sheet and the inner wall of the battery case, deformation or damage of the electrode plate may occur.

When the electrode plate is deformed, the electrode plate is apt to contact another electrode plate. Therefore, short-circuiting easily occurs across the electrode plate. Furthermore, when the battery case is formed of a conductive material such as aluminum, short-circuiting may occur due to a contact between the battery case and the electrode plate. On the other hand, as a method of preventing the electrode plate from being interposed in another member, a method to surround the stacked body by a frame may be considered to make the movement of the insulating plate to be difficult and to make the electrode plate locked into the frame.

In this case, when the frame is formed as one body, the frame makes the stacked body not to allow expanding without deterioration in age or in the charging of the secondary battery. Therefore, the stacked body or the frame may be damaged by unexpected stress. Such a problem also arises in a stacked lithium ion battery of a winding type, in which a positive electrode and a negative electrode are stacked with a separator and in which the electrodes are wound. Further, since the outer size of the integrally molded frame hardly changes, the workability may be degraded during the assembly of the secondary battery. On the contrary, when the frame is configured by arranging a plurality of independent insulating plates around a stacked body, the electrode plate moves between the plurality of insulating plates and gets stuck between the battery case and the insulating plate, in the case that the connection between the insulating plates is insufficient.

### SUMMARY OF THE INVENTION

The invention is made in view of such circumstances, and it is an object of the invention to provide a secondary battery capable of reducing occurrence of short-circuiting caused by damage or deformation to an electrode plate.

According to an aspect of the invention, a secondary battery includes: a battery case; a stacked body that is housed inside the battery case and includes a plurality of electrode plates; and a frame that is arranged between the stacked body and the battery case and formed by engaging a plurality of insulating plates with each other to surround the stacked body in an annular shape, wherein end surfaces of two of the insulating plates engaging with each other are respectively provided with an engaging portion or an engaged portion, and wherein the engaging portion formed in the end surface of one of the two insulating plates engages with the engaged portion of the other of the two insulating plates, in order that the stacked body is surrounded in an annular shape by the insulating plates.

Here, the stacked body means a body having units each of that includes both of the positive electrode plate and the negative electrode plate stacked with a separator interposed between the positive electrode and the negative electrode.

According to the secondary battery of the aspect of the invention, since the relative position between the plurality of insulating plates is fixed in a manner such that the frame is formed by engaging the engaging portion and the engaged portion formed in the insulating plates, it is possible to prevent a force fixing the relative position between the insulating plates from being decreased due to a deterioration of an adhesive, as compared with the configuration in which the insulating plates are fixed to each other by an adhesive or the like.

Here, the engaging portion is a portion, for example, a protruding piece protruding from the end surface of the insulating plate in relation to the other end surface portions, and the engaged portion is a portion which is a recess (or a groove) with a bottom portion or without a bottom portion, and which is, for example, a notch.

In the aspect of the invention, the adjacent insulating plates engage with each other at the engaging portion and the engaged portion. That is, the engaging portion is interposed between the insulating plates. Therefore, the electrode plates forming the stacked body are interrupted by the engaging portion between the insulating plates, so that it may not move between the frame and the inner wall of the battery case. Therefore, it is possible to prevent the electrode plate from being interfered with by the battery case and to prevent the electrode plate from being deformed or damaged.

Further, even when the stacked body is expanded due to the charging or the like, the position of the insulating plate may be changed in accordance with the expansion of the stacked body. Therefore, the electrode plate may be prevented from receiving an unexpected force due to the expansion of the stacked body, and the electrode plate may be prevented from being deformed or damaged due to the unexpected force.

According to the aspect of the invention, the electrode plate may be prevented from being interfered with by the battery case, and the electrode plate may be prevented from being deformed or damaged due to the interference with the battery case. Further, since the movement of the insulating plate is allowed in accordance with the expansion or the like of the stacked body, the electrode plate may be prevented from receiving an. unexpected force due to the expansion of the stacked body, and the electrode plate may be prevented from being deformed or damaged due to the unexpected force. In this manner, since the electrode plate is prevented from being deformed or damaged, short-circuiting caused by the deformation or the damage of the electrode plate is prevented.

### BRIEF DESCRIPTION OF THE DRAWINGS

FIG. 1 is an exploded view schematically illustrating a configuration of a secondary battery according to a first embodiment.

FIG. 2A is a cross-sectional view taken along the line A-A′ of FIG. 1, and FIG. 2B is a cross-sectional view taken along the line B-B′.

FIG. 3 is an exploded perspective view illustrating shapes of a first insulating plate and a second insulating plate.

FIG. 4A is a perspective view illustrating a spacer of a second embodiment, and FIG. 4B is an exploded perspective view illustrating shapes of a first insulating plate and a second insulating plate.

FIG. 5A is a perspective view illustrating a spacer of a third embodiment, and FIG. 5B is an exploded perspective view illustrating shapes of a first insulating plate and a second insulating plate.

FIG. 6 is an exploded perspective view illustrating shapes of a first insulating plate and a second insulating plate of a fourth embodiment.

FIG. 7 is a perspective view illustrating a shape of a fourth insulating plate of a fifth embodiment.

FIG. 8 is a perspective view illustrating a frame obtained by assembling a plurality of fourth insulating plates of the fifth embodiment.

### DETAILED DESCRIPTION OF THE INVENTION

Hereinafter, exemplary embodiments of the invention will be described by referring to the accompanying drawings. In the drawings to be used for description, the dimension or the scale of the structure in the drawings may be different from that of the real structure in order to easily, show the characteristic point. The same reference numerals are given to the same components of the embodiments, and the detailed description thereof will not be repeated. Further, for convenience and clarification, the insulating plates having different shapes are referred to as the first insulating plate and the second insulating plate. Furthermore, the technical scope of the invention is not limited to the embodiments below. Various modifications may be made within the scope of the spirit of the invention.

### First Embodiment

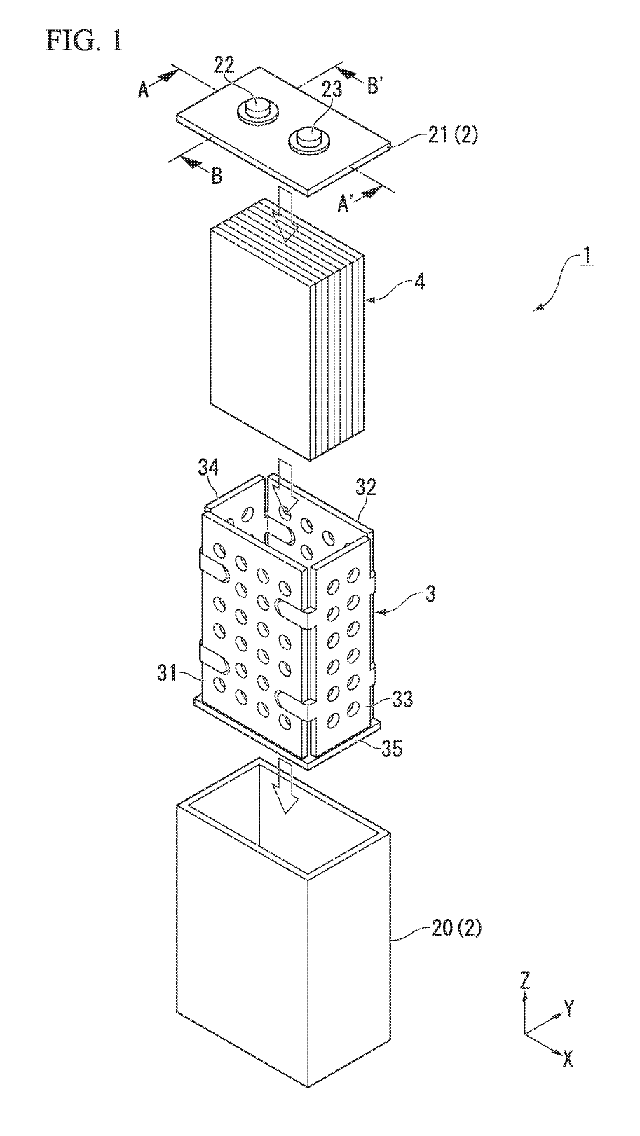

As shown in FIG. 1, a secondary battery 1 includes a hollow battery case 2, a spacer 3 serving as a frame, and a stacked body 4 formed by stacking a plurality of electrode plates. The secondary battery 1 is, for example, a lithium ion secondary battery. The spacer 3 and the stacked body 4 are stored in the battery case 2.

The spacer 3 is provided between the inner wall of the battery case 2 and the stacked body 4. As the spacer 3, there are a plurality of insulating plates (to be described later). The insulating plates of the spacer 3 connect with each other to surround the stacked body 4 in an annular shape. In a pair of insulating plates connecting with each other, at the edge of an insulating plate, there is an engaging portion. In the pair of insulating plates, at the edge of the other insulating plate, there is an engaged portion to be connected with the engaging portion.

The battery case 2 includes a battery case body 20 having an opening and a cover 21 closing the opening and sealing the battery case body 20. The outer shape, the inner shape, or the material of the battery case 2 is not limited. In the battery case body 20 of the embodiment, the outer shape is a substantially rectangular parallelepiped shape, and the shape of the cross-section parallel to the opening surface including the opening is a substantially rectangular frame shape. The planar shape of the cover 21 is a substantially rectangular shape. The battery case body 20 and the cover 21 are formed of, for example, aluminum, and are connected to each other by, for example, welding or the like. Furthermore, the battery case 2 of the embodiment is referred to as a square battery case.

Hereinafter, the positional relation between the components of the secondary battery 1 will be described on the basis of the XYZ orthogonal coordinate system shown in FIG. 1. In the XYZ orthogonal coordinate system or the rectangular coordinate system, the X direction and the Z direction correspond to the direction along the main surface of the electrode plate forming the stacked body 4. Here, the X direction corresponds to the direction along the opening surface of the battery case body 20, and the Z direction corresponds to the direction perpendicular to the opening surface of the battery case body 20. The Y direction corresponds to the direction for stacking the electrode plates in the stacked body 4. The X axis, the Y axis, and the Z axis are perpendicular to each other. One side of the X direction may be referred to as the +X direction, the other side of the X direction is referred to as the −X direction, and the same applies to the Y direction and the Z direction.

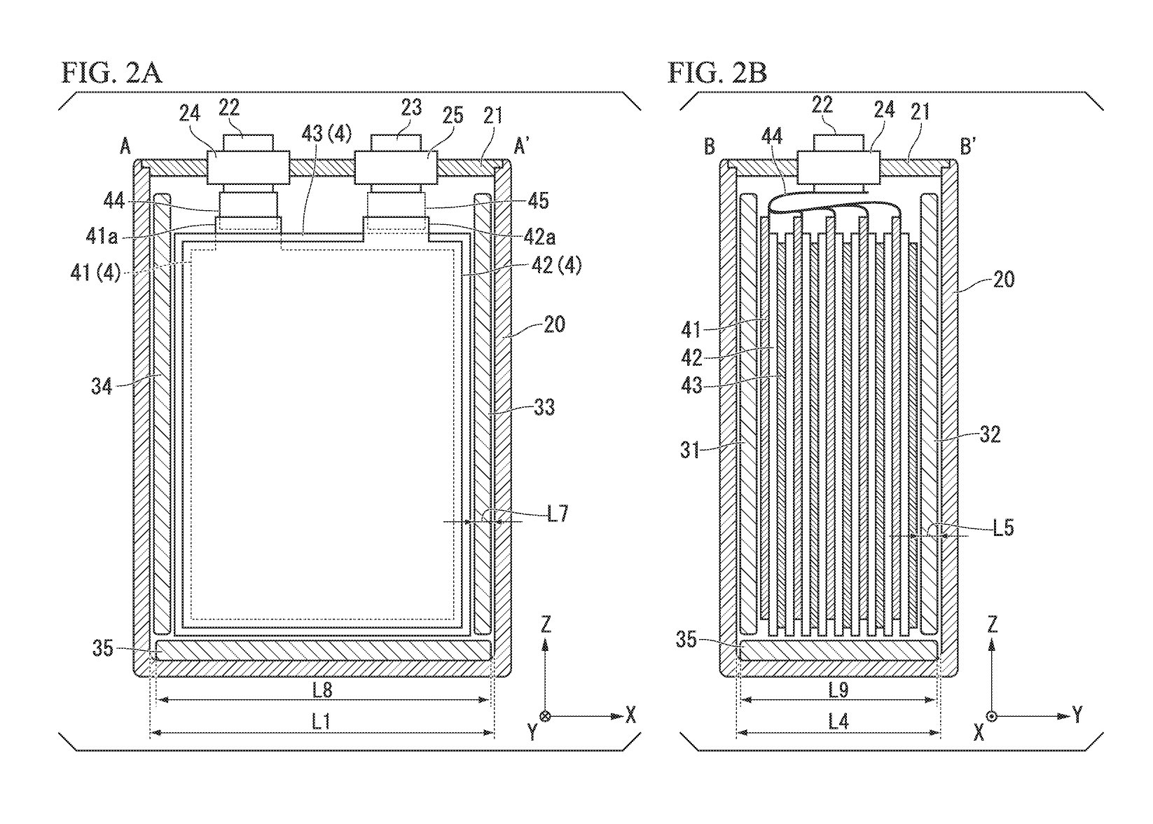

As shown in FIG. 2A, the cover 21 is provided with a positive electrode terminal 22 and a negative electrode terminal 23 protruding toward the outside of the secondary battery 1. The secondary battery 1 may be charged and discharged through the positive electrode terminal 22 and the negative electrode terminal 23. Here, the cover 21 is provided with substantially annular fixing members 24 and 25. The fixing members 24 and 25 are formed of, for example, a thermoplastic resin or a hot-setting resin as insulating materials, and are members that fix the positive electrode terminal 22 or the negative electrode terminal 23 to the cover 21. The positive electrode terminal 22 is fixed to the cover 21 by the fixing member 24. The negative electrode terminal 23 is fixed to the cover 21 by the fixing member 25.

As shown in FIGS. 2A and 2B, the stacked body 4 has a structure in which positive electrode plates 41 and negative electrode plates 42 are stacked with separators 43 each of that is interposed between a positive electrode plate 41 and an negative electrode plate 42 arranged adjacent to the positive electrode plate 41. Here, the positive electrode plates 41 and the negative electrode plates 42 are alternately arranged in the Y direction. Each of the separators 43 is positioned between each positive electrode plate 41 and each negative electrode plate 42. Therefore, the positive electrode plate 41 does not directly contact the negative electrode plate 42.

The positive electrode plate 41 and the negative electrode plate 42 are formed of a plate-shaped or foil-shaped material (i.e., a collector), and a film formed of an electrode active material is provided on the surface of the material. The collector is formed of, for example, aluminum or copper, and in the embodiment, aluminum is used as a collector for the positive electrode and copper is used as a collector for the negative electrode. The electrode active material may be appropriately selected in accordance with the type of electrolyte. The separator 43 is formed of, for example, an insulating material such as a porous resin film (polypropylene, polyethylene, or the like).

In the positive electrode plate 41, at the end in the Z direction, a positive electrode tab 41a is formed, which is located to the −X direction from the center of the positive electrode plate 41 in the X direction. The positive electrode tab 41a is electrically connected to the connection portion 44 (hereinafter, referred to as an electrical connection). As shown in FIG. 2B, a connection portion 44 is commonly connected to the positive electrode plates 41. The connection portion 44 is also electrically connected to the positive electrode terminal 22.

In the negative electrode plate 42, at the end in the Z direction, a negative electrode tab 42a is formed, which is located to the +X direction from the center of the negative electrode plate 42 in the X direction. The negative electrode tab 42a is eclectically connected to the connection portion 45. In the same way as in the positive electrode plate 41, a connection portion 45 is commonly connected to the negative electrode plates 42. The connection portion 45 is electrically connected to the negative electrode terminal 23.

As shown in FIG. 1, the spacer 3 has a structure in which first insulating plates 31 and 32, second insulating plates 33 and 34, and a third insulating plate 35 are combined with each other. The plurality of insulating plates 31 to 35 is all formed of an insulating material, and here is formed of plastic. The first insulating plates 31 and 32 and the second insulating plates 33 and 34 are side plates arranged in an annular shape along the inner wall of the battery case 2. Here, the annular shape indicates a state in which the stacked body 4 is surrounded. Therefore, the battery case 2 and the stacked body 4 are separated from each other. The insulating plate 35 is a bottom plate that is disposed in the stacked body 4 so as to be located at the opposite side of the opening of the battery case 2.

The first insulating plates 31 and 32 are arranged to face each other. The main surfaces of the first insulating plates 31 and 32 are set to be substantially parallel to the main surface (XZ plane) of the positive electrode plate 41. The second insulating plates 33 and 34 are arranged to face each other. The main surfaces of the second insulating plates 33 and 34 are set to be substantially perpendicular to the first insulating plates 31 and 32.

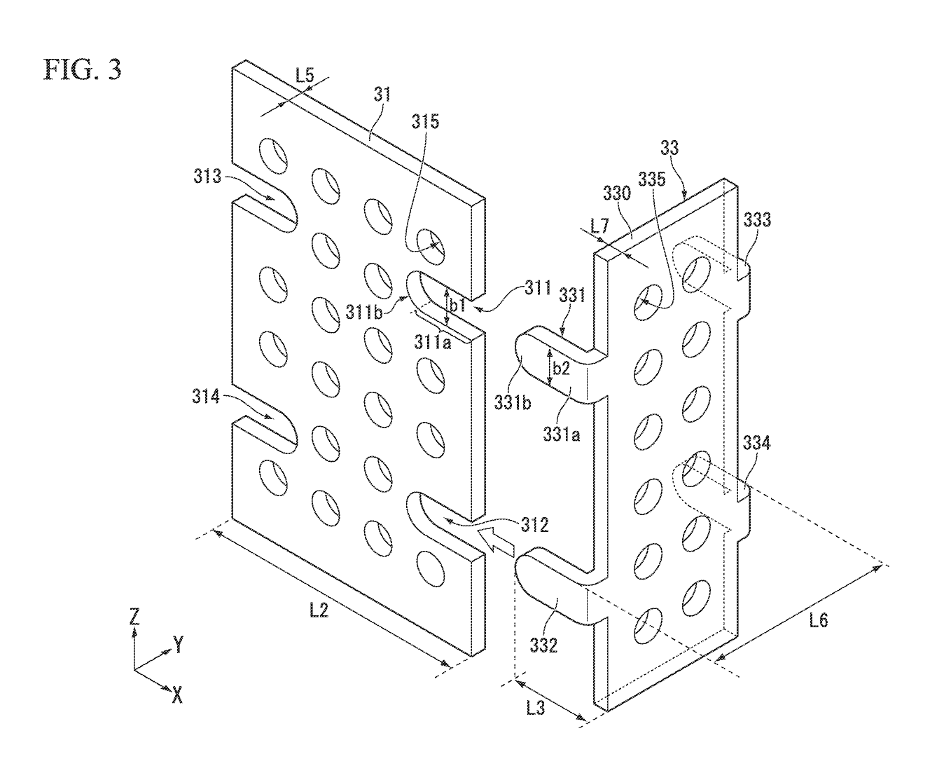

As shown in FIG. 3, the first insulating plate 31 includes a plurality of notches 311 to 314 and a plurality of through-holes 315. The notches 311 to 314 correspond to the engaged portions of the invention, and each becomes a portion to engage with and connect to the engaging portion (protrusion piece) to be described later. Here, “to engage the engaging portion with the engaged portion” means to make two or more insulating plates having the engaging portion or the engaged portion fitted to each other, and to make at least one of the insulating plates movable with keeping to fit the engaging portion to the engaged portion, although the engaging portion may slide within the engaged portion. The notches 311 to 314 and the through-holes 315 penetrate through the first insulating plate 31 in the plate thickness direction (Y direction). The plurality of notches 311 to 314 serves as a guide with respect to the protrusion piece to be described later. The first insulating plate 32 is the same as the first insulating plate 31.

The notch 311 extends in the X direction. The notch 311 includes a linear portion 311a that extends in a substantially linear band shape and that is connected to the end of the first insulating plate 31 in the +X direction, and a curved portion 311b that is located at the opposite side of the end. The notch 312 is formed in the same shape as that of the notch 311, and is formed near the −Z direction in relation to the notch 311.

The notches 313 and 314 are provided to be symmetrical to the notches 311 and 312 with respect to the symmetrical axis parallel to the Z direction. The notches 313 and 314 are formed in the same shape as that of the notch 311, and extend in the X direction. The notch 314 is formed near the −Z direction in relation to the notch 313.

The second insulating plate 33 includes a base portion 330, a plurality of protrusion pieces 331 to 334, and a plurality of through-holes 335. The base portion 330 is a portion formed in a substantially flat plate shape, and the main surface of the flat plate is set to be substantially parallel to the YZ plane. Each of the plurality of through-holes 335 penetrates through the base portion 330 in the plate thickness direction (X direction).

As described above, the protrusion piece 33.1 corresponds to the engaging portion of the invention, and includes an arm portion 331a and a front end 331b. The arm portion 331a is curved to the −X direction and connected to the end of the base portion 330 near the −Y direction. In the arm portion 331a, the front end side is formed in a substantially linear band shape in relation to the curved portion, and extends in the direction intersecting the main surface of the base portion 330. The front end 331b is connected to the arm portion 331a continuously. The outer shape of the front end 331b is substantially the same as the inner shape of the curved portion 311b of the notch 311, and here, the corner of the arm portion 331a is formed to be round.

The protruding direction of the protrusion piece 331 is not limited as long as at least a part of the protrusion piece 331 may engage with the notch 311, that is, the protrusion piece 331 intersects the notch 311. In the embodiment, the substantially linear band-shaped portion of the arm portion 331a as the engaging portion engaging with the notch 311 and the front end 331b extend in the direction (−X direction) perpendicular to the main surface of the base portion 330, and the protruding direction is set as the direction perpendicular to the main surface of the base portion 330.

The protrusion piece 332 is formed in the same shape as that of the protrusion piece 331, and is formed near the −Z direction in relation to the protrusion piece 331. The positions of the protrusion pieces 331 and 332 and the notches 311 and 312 are set in order that the protrusion piece 332 engages with the notch 312 while the protrusion piece 331 engages with the notch 311.

When the protrusion pieces 331 and 332 engage with the notches 311 and 312, the relative position between the first insulating plate 31 and the second insulating plate 33, with respect to the width direction (Z direction) of the protrusion pieces 331 and 332, hardly changes. Further, the relative position between the first insulating plate 31 and the second insulating plate 33 can be changed in the protruding direction (X direction) and the plate thickness direction (Y direction) of the protrusion pieces 331 and 332. Specifically, the width b1 of each linear portion of the notches 311 and 312 is set to be substantially equal to the width b2 of each arm portion of the protrusion pieces 331 and 332 in the range where the protrusion pieces 331 and 332 are able to slide inside the notches 311 and 312:

The amount (hereinafter, referred to as an allowable movement amount), allowed for the relative position between the first insulating plate 31 and the second insulating plate 33 with keeping the engagement, is substantially determined by the dimensions of the notches 311 and 312, the dimensions of the protrusion pieces 331 and 332, the dimension of the first insulating plate 31, the dimension of the second insulating plate 33, or the like. The upper limit of each allowable movement amount of the protrusion pieces 331 and 332 in the protruding direction (here, the X direction) corresponds to each dimension of the protrusion pieces 331 and 332 or the notches 311 and 312 in the protruding direction. The upper limit of each allowable movement amount of the protrusion pieces 331 and 332 in the plate thickness direction (here, the Y direction) corresponds to each depth of the notches 311 and 312 (here, the plate thickness of the first insulating plate 31).

Since the dimensions of the protrusion pieces 331 and 332 and the dimensions of the notches 311 and 312 in the protruding direction have a larger degree of freedom in selection than the plate thickness of the first insulating plate 31, the upper limit of the allowable movement amount may be easily increased in the protruding direction of the protrusion piece compared to the plate thickness direction of the protrusion piece. From this viewpoint, the direction, in which the amount of the relative position between the first insulating plate 31 and the second insulating plate 33 is expected to be relatively large, may be set as the protruding direction. For example, when the direction, in which the expansion amount of the stacked body 4 expanded by the charging or the like is relatively large, is set as the protruding direction, the first insulating plate 31 or the second insulating plate 33 may be easily moved in accordance with the expansion of the stacked body 4 while the engagement is maintained. Furthermore, the upper limit of the allowable movement amount in the Y direction may be increased by allowing the protruding direction of the protrusion piece to intersect the main surface of the first insulating plate.

The protrusion pieces 333 and 334 are provided to be symmetrical to the protrusion pieces 331 and 332 with respect to the center line (the line parallel to the Z axis) dividing the base portion 330 into two parts in the YZ plane. The protrusion piece 333 includes an arm portion and a front end which are the same as those of the protrusion piece 331. The arm portion of the protrusion piece 333 is curved to the −X direction and connected to the end of the base portion 330 near the +Y direction, and the front end side is formed in a substantially linear band shape in relation to the curved portion. The front end of the protrusion piece 333 protrudes in the −X direction and is continuously connected to the arm portion. And the corner is formed to be round. The protrusion piece 334 is formed in the same shape as that of the protrusion piece 333, and is formed near the −Z direction in relation to the protrusion piece 331. Furthermore, in the embodiment, the protrusion pieces 333 and 334 and the protrusion pieces 331 and 332 are provided to be symmetrical to each other with respect to the above-described center line, but the invention is not limited thereto. That is, they may not be symmetrical to each other and the number of the protruding pieces may be different as long as the insulating plate matches another insulating plate. When the protrusion pieces 333 and 334 and the protrusion pieces 331 and 332 are provided to be symmetrical to each other, the first insulating plate and the second insulating plate may be manufactured as one type respectively, which may contribute to a reduction in manufacturing cost.

The notches 313 and 314 of the first insulating plate 31 engage with the protrusion pieces (refer to FIG. 1) of the second insulating plate 34 near the −Y direction. The protrusion pieces 333 and 334 of the second insulating plate 33 engage with the notches of the first insulating plate 32 near the +X direction. The protrusion piece of the second insulating plate 34 near the +Y direction engages with the notch of the first insulating plate 32 near the −X direction. In this manner, the first insulating plates 31 and 32 and the second insulating plates 33 and 34 engage with each other to be connected in an annular shape with surrounding the stacked body 4, and are arranged inside the battery case 2. The outer dimension of the first insulating plate 31, the outer dimension of the second insulating plate 33, and the inner dimension of the battery case 2 are set, for example, as described below (refer to FIGS. 2A, 2B, and 3).

The inner dimension of the battery case 2 in the X direction is set to L1, the outer dimension of the first insulating plate 31 in the X direction is set to L2, and the outer dimension of the second insulating plate 33 in the X direction is set to L3. L3 indicates a gap between the surface of the second insulating plate 33 in the +X direction and the front end of the protrusion piece (for example, the protrusion piece 332). Here, L1 to L3 are set to satisfy the following Equation (1).

L1−2×L3<L2<L1 (1)

As L2 becomes smaller than L1, the first insulating plate 31 may be more easily housed inside the battery case 2, and the secondary battery 1 may be efficiently assembled. As shown in the left side of Equation (1), when L2 becomes larger than a difference between L1 and twice L3, the protrusion piece 331 does not come off from the notch 311 in the X direction in the case that the protrusion piece 331 and the notch 311 engage with each other inside the battery case 2.

In the embodiment, L3 is substantially determined by the plate thickness of the base portion 330 and the dimensions of the protrusion pieces 331 to 334 in the protruding direction. Since the dimensions of the protrusion pieces 331 to 334 in the protruding direction may be easily increased in the X direction compared to the case of increasing the plate thickness of the base portion 330, the protrusion piece 331 may be easily set so as not to come off from the notch 311 in the X direction.

Because the necessity of increasing the plate thickness of the base portion 330 reduces from the viewpoint of preventing a deviation in the engagement, the secondary battery 1 may be decreased in weight, and a space for receiving the stacked body 4 or an electrolyte may be easily ensured inside the battery case 2.

The inner dimension of the battery case 2 in the Y direction is set to L4, the outer dimension, that is, the plate thickness of the first insulating plate 31 in the Y direction is set to L5, and the outer dimension of the second insulating plate 33 in the Y direction is set to L6. For example, L6 indicates a gap between the end surface of the protrusion piece 332 near the −Y direction and the end surface of the protrusion piece 334 near the +Y direction. Here, L4 to L6 are set to satisfy the following Equation (2).

L4−2×L5<L6<L4 (2)

As L6 becomes smaller than L4, the second insulating plate 33 may be more easily housed inside the battery case 2, and the secondary battery 1 may be efficiently assembled. As shown in the left side of Equation (2), when L6 becomes larger than a difference between L4 and twice L5, the protrusion piece 331 does not come off from the notch 311 in the Y direction, because the protrusion piece 331 and the notch 311 engage with each other inside the battery case 2.

The third insulating plate 35 is formed of, for example, a plate member having a substantially rectangular shape in the plan view. The dimension of the third insulating plate 35 is set, for example, as described below. The outer dimension, that is, the plate thickness of the second insulating plate 33 in the X direction is set to L7, and the outer dimension of the third insulating plate 35 in the X direction is set to L8. Here, L1, L7, and L8 are set to satisfy the following Equation (3).

L1−2×L7<L8<L1 (3)

As L8 becomes smaller than L1, the third insulating plate 35 may be more easily housed inside the battery case 2, and the secondary battery 1 may be efficiently assembled. As shown in the left side of Equation (3), when L8 becomes larger than a difference between L1 and twice L7, the second insulating plates 33 and 34 do not enter the gap between the inner wall of the battery case 2 and the outer periphery of the third insulating plate 35. That is, because the third insulating plate 35 is arranged without a gap between the second insulating plates 33 and 34 in the −Z direction, a part of the stacked body 4 between the second insulating plates 33 and 34 is reliably prevented from contacting the bottom portion of the battery case 2.

When the outer dimension of the third insulating plate 35 in the Y direction is set to L9, here L4, L5, and L9 are set to satisfy the following Equation (4).

L4−2×L5<L9<L4 (4)

As L9 becomes smaller than L4, the third insulating plate 35 may be more easily housed inside the battery case 2, and the secondary battery 1 may be efficiently assembled. As shown in the left side of Equation (4), when L9 becomes larger than a difference between L4 and twice L5, the first insulating plates 31 and 32 do not enter a gap between the inner wall of the battery case 2 and the outer periphery of the third insulating plate 35. That is, because the third insulating plate 35 is arranged without a gap between the first insulating plates 31 and 32 in the −Z direction, a part of the stacked body 4 between the first insulating plates 31 and 32 is reliably prevented from contacting the bottom portion of the battery case 2.

In the secondary battery 1 with the above-described configuration, because the protrusion pieces 331 and 332 respectively engage with the notches 311 and 312, the relative position between the first insulating plate 31 and the second insulating plate 33 is substantially fixed. Therefore, it is possible to prevent a force for fixing the relative position between the first insulating plate 31 and the second insulating plate 33 from being degraded due to deterioration of an adhesive, as compared with a configuration in which the plurality of insulating plates is fixed to each other by the adhesive.

Because the relative position between the first insulating plate 31 and the second insulating plate 33 is able to change in the protruding direction (X direction) and in the plate thickness direction (Y direction) of the protrusion pieces 331 and 332, when the stacked body 4 is expanded due to the charging or the like, the position of the first insulating plate 31 or the second insulating plate 33 may be changed in accordance with the expansion of the stacked body 4. Therefore, it is possible to prevent an unexpected force from being applied to the electrode plate with the expansion, and prevent the damage of the electrode plate or the short-circuiting of the battery due to the expansion.

When the relative position between the first insulating plate 31 and the second insulating plate 33 changes in the protruding direction, because the protrusion pieces 331 and 332 are present between the first insulating plate 31 and the second insulating plate 33, the electrode plate hardly enters between the first insulating plate 31 and the second insulating plate 33. Therefore, it is possible to prevent the electrode plate from being interfered with the inner wall of the battery case 2 and to prevent the electrode plate from being deformed or damaged due to the interference with the battery case 2.

Because the first insulating plates 31 and 32 have the through-holes (for example, the through-holes 315), and the second insulating plates 33 and 34 have the through-holes (for example, the through-holes 335), an electrolyte may move into or out of the spacer 3 through the through-holes. Accordingly, it is possible to almost remove a difference between the pressure at the inside of the spacer 3 and the pressure of the outside of the spacer 3, when the electrolyte moves into and out of the spacer 3 in accordance with the expansion of the stacked body. Further, it is possible to prevent the amount of electrolyte contributing to the charging and the discharging from being decreased due to its residence and to prevent the electrolyte from being degraded due to its residence.

As described above, since it is possible to drastically reduce a problem such as short-circuiting of the secondary battery 1, a secondary battery system equipped with the secondary battery 1 may be stably operated. Furthermore, as an example of the secondary battery system, for example, an electrical machine such as an electrical vehicle, a hybrid vehicle, an industrial vehicle, a ship, and an airplane essentially using power of a secondary battery may be used.

### Second Embodiment

Next, a secondary battery of a second embodiment will be described. The second embodiment is different from the first embodiment in that the notch of the first insulating plate is formed by a groove and the direction along the main surface of the second insulating plate corresponds to the protruding direction of the protrusion piece. Since the battery case 2 and the stacked body 4 are the same as those of the first embodiment, they may be described if necessary by referring to FIG. 1.

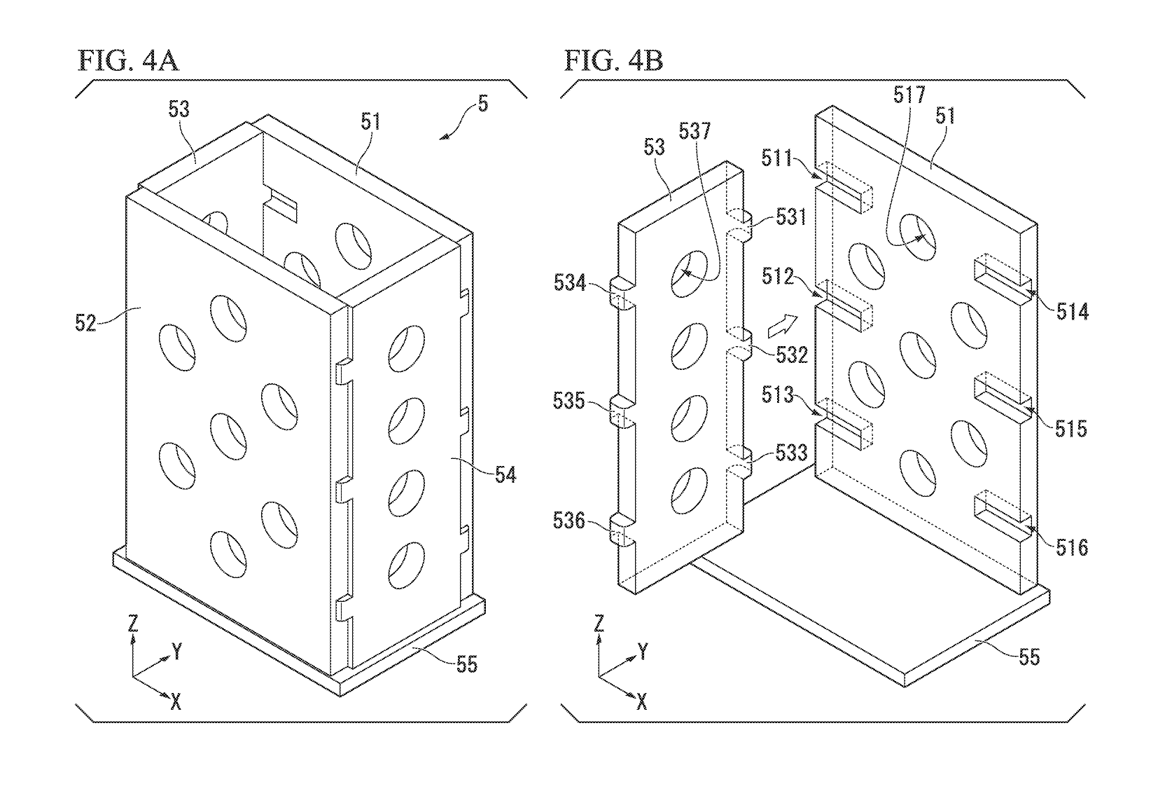

As shown in FIG. 4A, a spacer 5 includes first insulating plates 51 and 52, second insulating plates 53 and 54, and a third insulating plate 55. The positional relation between the insulating plates 51 to 55 is the same as that of the first embodiment. The first insulating plates 51 and 52 and the second insulating plates 53 and 54 are side plates surrounding the stacked body 4 (refer to FIG. 1). The third insulating plate 55 is a bottom plate arranged in the −Z direction in relation to the stacked body 4.

The first insulating plate 51 includes a plurality of notches 511 to 516 and a plurality of through-holes 517. The through-holes 517 penetrate through the first insulating plate 51 in the plate thickness direction (Y direction). The notches 511 to 516 have openings in the direction (here, the −Y direction) facing the stacked body 4, are formed by grooves each having a bottom portion near the +Y direction.

The notches 511 to 516 extend in the X direction. The notches 511 to 513 are connected to the end of the first insulating plate 51 near the −X direction. The notches 514 to 516 are connected to the end of the first insulating plate 51 near the +X direction. The notch 512 is formed near the −Z direction in relation to the notch 511, and the notch 513 is formed near the −Z direction in relation to the notch 512. The notch 515 is formed near the −Z direction in relation to the notch 514, and the notch 516 is formed near the −Z direction in relation to the notch 515.

The first insulating plate 52 is the same as the first insulating plate 51. The first insulating plates 51 and 52 are formed in order that all main surfaces thereof are substantially parallel to the XZ plane, and that the openings of the notches of the first insulating plates 51 and 52 are arranged to face each other.

The second insulating plate 53 includes a plurality of protrusion pieces 531 to 536 and a plurality of through-holes 537. The second insulating plate 53 is formed in order that the main surface thereof is substantially parallel to the YZ plane. The through-hole 537 penetrates through the second insulating plate 53 in the plate thickness direction (X direction).

The protrusion pieces 531 to 533 are formed in the second insulating plate 53 near the +Y direction, and protrude toward the first insulating plate 51 along the main surface of the second insulating plate 53. The protrusion pieces 534 to 536 are formed in the second insulating plate 53 near the −Y direction, and protrude toward the first insulating plate 52 along the main surface of the second insulating plate 53. The second insulating plate 54 is the same as the second insulating plate 53, and the main surface thereof is substantially parallel to the YZ plane.

The notches 511 to 513 of the first insulating plate 51 respectively engage with the protrusion pieces 531 to 533 of the second insulating plate 53. The notches 514 to 516 of the first insulating plate 51 respectively engage with the protrusion pieces of the second insulating plate 54 near the +Y direction. The protrusion pieces 534 to 536 of the second insulating plate 53 respectively engage with the notches of the first insulating plate 52 near the −X direction. The notch of the first insulating plate 52 near the +X direction engages with the protrusion piece of the second insulating plate 54 near the −Y direction. In this manner, the first insulating plates 51 and 52 and the second insulating plates 53 and 54 are connected to each other in an annular shape to surround the stacked body 4.

In the spacer 5 with the above-described configuration, due to the same reason as that of the first embodiment, it is possible to prevent the electrode plate from being interfered by the battery case 2 and to prevent an unexpected force from being applied to the electrode plate due to the expansion of the stacked body 4. Therefore, it is possible to drastically reduce the deformation or the damage of the electrode plate, and to prevent the short-circuiting caused by the deformation or the damage of the electrode plate.

Further, since the notch (for example, the notch 511) of the first insulating plate is formed in a groove shape, the protrusion piece (for example, the protrusion piece 531) does not contact with the member arranged at the opposite side of the opening of the notch 511 with respect to the first insulating plate. Since this member (here, the battery case 2) does not contact with the protrusion piece 531, the damage due to the contact is prevented.

Furthermore, as in the second insulating plate of the first embodiment, the notch may be provided in a groove shape in the first insulating plate with respect to the protrusion piece protruding in the direction perpendicular to the main surface of the second insulating plate. In this case, for example when the first insulating plate is arranged in order that the opening of the notch faces the battery case 2, the protrusion piece may not contact the electrode plate. Accordingly, it is possible to prevent the electrode active material from being peeled off from the electrode plate due to the contact between the protrusion piece and the electrode plate.

### Third Embodiment

Next, a secondary battery of a third embodiment will he described. The third embodiment is different from the second embodiment in that the dimension of the protrusion piece of the second insulating plate in the protruding direction (Y direction) is larger than the plate thickness of the first insulating plate.

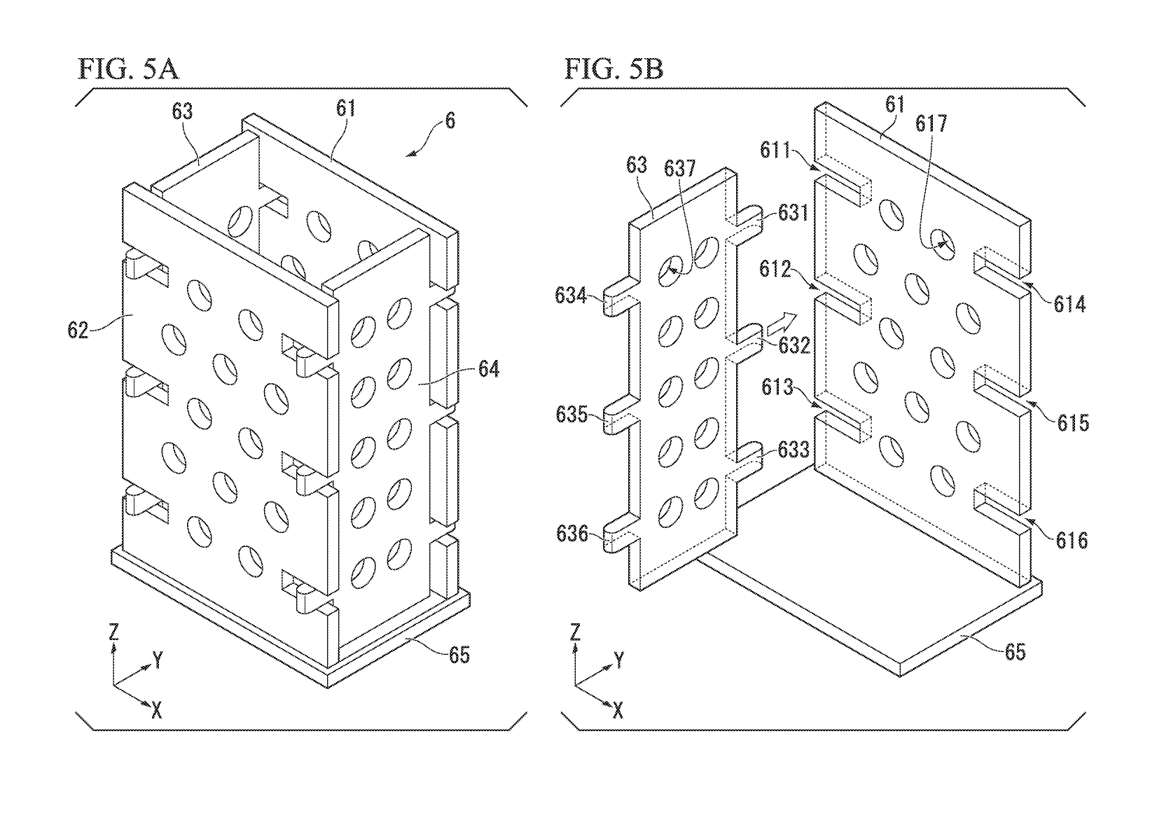

As shown in FIG. 5A, a spacer 6 includes first insulating plates 61 and 62, second insulating plates 63 and 64, and a third insulating plate 65. The positional relation between the insulating plates 61 to 65 is the same as that of the first embodiment. The first insulating plates 61 and 62 and the second insulating plates 63 and 64 are side plates arranged to surround the stacked body 4 (refer to FIG. 1). The third insulating plate 65 is a bottom plate that is arranged in the −Z direction in relation to the stacked body 4.

The first insulating plate 61 includes a plurality of notches 611 to 616 and a plurality of through-holes 617. The notches 611 to 616 and the through-hole 617 penetrate through the first insulating plate 61 in the plate thickness direction (Y direction). The first insulating plate 62 is the same as the first insulating plate 61. The first insulating plates 61 and 62 are formed in order that all main surfaces are substantially parallel to the XZ plane.

The notches 611 to 616 extend in the X direction. The notches 611 to 613 are connected to the end of the first insulating plate 61 near the −X direction. The notches 614 to 616 are connected to the end of the first insulating plate 61 near the +X direction. The notch 612 is formed near the −Z direction in relation to the notch 611, and the notch 613 is formed near the −Z direction in relation to the notch 612. The notch 615 is formed near the −Z direction in relation to the notch 614, and the notch 616 is formed near the −Z direction in relation to the notch 615.

The second insulating plate 63 includes a plurality of protrusion pieces 631 to 636 and a plurality of through-holes 637. The main surface of the second insulating plate 63 is substantially parallel to the YZ plane. The through-holes 637 penetrate through the second insulating plate 63 in the plate thickness direction (X direction).

The protrusion pieces 631 to 633 are formed in the second insulating plate 63 near the +Y direction, and protrude toward the first insulating plate 61. The protrusion pieces 634 to 636 are formed in the second insulating plate 63 near the −Y direction, and protrude toward the first insulating plate 62. The dimensions of the protrusion pieces 631 to 633 in the protruding direction (Y direction) become larger than the plate thickness of the first insulating plate 61. The second insulating plate 64 is the same as the second insulating plate 63, and the main surface thereof is substantially parallel to the YZ plane.

The notches 611 to 613 of the first insulating plate 61 respectively engage with the protrusion pieces 631 to 633 of the second insulating plate 63. The notches 614 to 616 of the first insulating plate 61 respectively engage with the protrusion pieces of the second insulating plate 64 near the +Y direction. The protrusion pieces 634 to 636 of the second insulating plate 63 respectively engage with the notches of the first insulating plate 62 near the −X direction. The notches of the first insulating plate 62 near the +X direction respectively engage with the protrusion pieces of the second insulating plate 64 near the −Y direction. In this manner, the first insulating plates 61 and 62 and the second insulating plates 63 and 64 are connected to each other in an annular shape with respect to the stacked body 4.

In the spacer 6 with the above-described configuration, due to the same reason as that of the first embodiment, it is possible to prevent the electrode plate from being interfered with the battery case 2 and to prevent an unexpected force from being applied to the electrode plate due to the expansion of the stacked body 4. Therefore, it is possible to drastically reduce the deformation or the damage of the electrode plate, and to prevent the short-circuiting caused by the deformation or the damage of the electrode plate.

Further, since the protrusion piece (for example, the protrusion piece 631) of the second insulating plate protrudes in the direction along the main surface of the second insulating plate 63, it is possible to easily increase the dimension of the protrusion piece 631 in the protruding direction. Therefore, it is possible to easily increase the upper limit of the amount (allowable movement amount) allowed in the relative position between the first insulating plate 61 and the second insulating plate 63 in the Y direction. For example, it is possible to easily move the first insulating plate 61 or the second insulating plate 63 in accordance with the expansion of the stacked body 4 in the lamination direction.

### Fourth Embodiment

Next, a secondary battery of a fourth embodiment will be described. The fourth embodiment is different from the third embodiment in that a pad portion is provided to press the insulating plate in the direction from the insulating plate toward the electrode plate. In the fourth embodiment, the arrangement of the plurality of insulating plates including the first insulating plate and the second insulating plate is the same as that of the third embodiment. Here, the pad portion is a portion to be pressed against the inner surface of the battery case 2 by the expanded stacked body and to be deformed elastically when the battery expands, and to press the inner surface of the battery case 2 due to a repulsive force of the elastic deformation in order that the insulating plate as a frame adheres to the stacked body when the battery contracts.

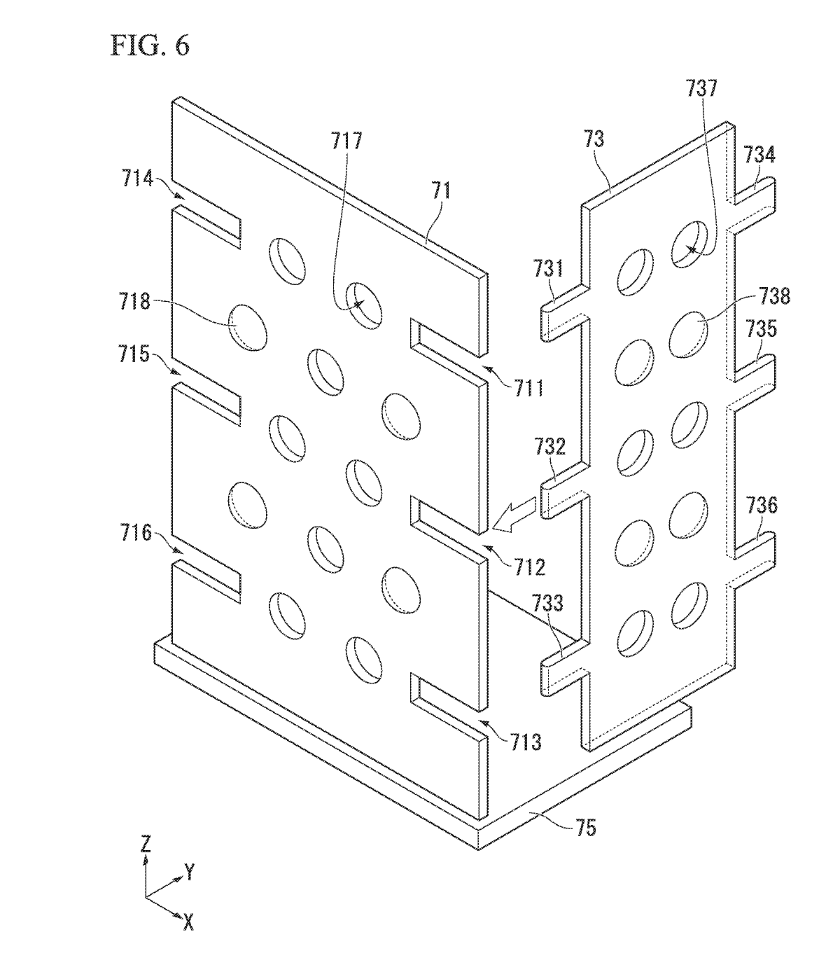

As shown in FIG. 6, a first insulating plate 71 includes a plurality of notches 711 to 716 and a plurality of through-holes 717. The notches 711 to 716 are the same as the notches 611 to 616 of the third embodiment. The through-hole 717 is the same as the through-hole 617 of the third embodiment.

In the first insulating plate 71, there are pad portions 718 on a surface facing the inner wall of the battery case 2. In the embodiment, the pad portions 718 are integrally formed with the first insulating plate 71 by the same material. Each of the pad portions 718 is formed as a protrusion that protrudes from the main surface of the first insulating plate 71 in the −Y direction.

In fact, when the first insulating plate 71 is housed inside the battery case 2, the first insulating plate 71 is pressed against the inner wall of the battery case 2 by the stacked body 4. The pad portion 718 is elastically deformed when it is pressed against the inner wall of the battery case 2, and presses the first insulating plate 71 due to an elastic repulsive force. Due to the force, the first insulating plate 71 is pressed toward the stacked body 4.

The second insulating plate 73 includes a plurality of protrusion pieces 731 to 736 and a plurality of through-holes 737.

The protrusion pieces 731 to 736 are the same as the protrusion pieces 631 to 636 of the third embodiment. The through-hole 737 is the same as the through-hole 637 of the third embodiment.

In the second insulating plate 73, there are pad portions 738 on a surface facing the inner wall of the battery case 2. In the embodiment, the pad portions 738 are integrally formed with the second insulating plate 73 by the same material. Each of the pad portions 738 is formed as a protrusion that protrudes from the main surface of the second insulating plate 73 in the +X direction. As in the first insulating plate 71, when the second insulating plate 73 is housed inside the battery case 2, it is pressed against the inner wall of the battery case 2 by the stacked body 4. The pad portion 738 is compressed and elastically deformed when it is pressed against the inner wall of the battery case 2, and the second insulating plate 73 is pressed toward the stacked body 4 due to an elastic repulsive force.

In the spacer with the above-described configuration, due to the same reason as that of the first embodiment, it is possible to prevent the electrode plate from being interfered with by the battery case 2 and to prevent an unexpected force from being applied to the electrode plate due to the expansion of the stacked body 4. Therefore, it is possible to drastically reduce the deformation or the damage of the electrode plate, and to prevent the short-circuiting caused by the deformation or the damage of the electrode plate. Further, due to the same reason as that of the third embodiment, it is possible to easily move the first insulating plate 71 or the second insulating plate 73 in accordance with the expansion of the stacked body 4 in the stacked direction.

Further, since the first insulating plate 71 and the second insulating plate 73 are pressed toward the stacked body 4, the first insulating plate 71 and the second insulating plate 73 are able to contact with the stacked body 4.

Therefore, it is possible to drastically prevent the electrode plate from entering a gap between the first insulating plate 71 and the second insulating plate 73.

Further, since the pad portions 718 and 738 are provided, it is possible to apply a desired compressing force to the stacked body 4, and to prevent a position deviation between the positive electrode plate 41, the negative electrode plate 42, and the separator 43.

Furthermore, as the pad portion, the pad portion may press at least one of the first insulating plate and the second insulating plate toward the stacked body 4, and may be provided only in, for example, the first insulating plate or the second insulating plate. Further, the pad portion may include a component independent from the first insulating plate or the second insulating plate, and may be provided, for example, with a plate spring made of an insulating material as a pad portion, which is inserted between the first insulating plate and the battery case.

### Fifth Embodiment

Next, a secondary battery of a fifth embodiment will be described. The fifth embodiment is different from the fourth embodiment in that the first insulating plate and the second insulating plate are connected to form one body as a fourth insulating plate. In the fifth embodiment, the shape of the fourth insulating plate is formed such that one end of the first insulating plate and one end of the second insulating body according to the first to fourth embodiments are bonded to each other.

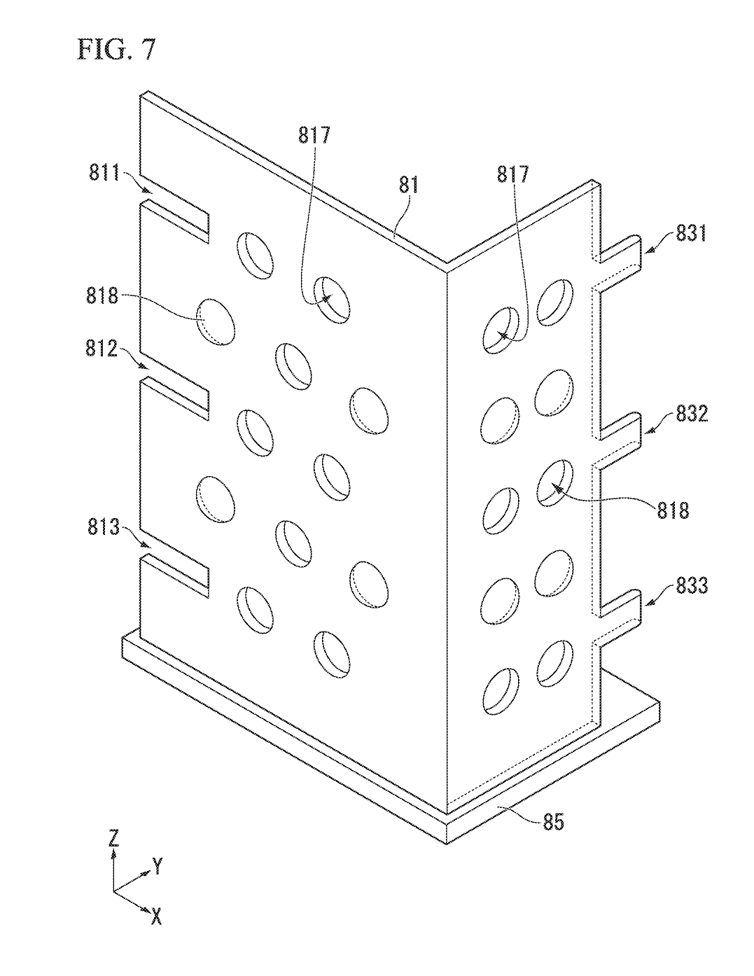

As shown in FIG. 7, a fourth insulating plate 81 includes a plurality of notches 811 to 813 provided at the end thereof in the −X direction, and includes a plurality of through-holes 817 and pad portions 818 provided on the surface facing the battery case 2, that is, the main surface of the fourth insulating plate 81. Further, the protrusion pieces 831 to 833 are provided at the end of the fourth insulating plate 81 in the +Y direction so as to be located at positions respectively correspond to the notches 811 to 813. The notches 811 to 813 are the same as the notches 711 to 713 of the fourth embodiment. The through-holes 817 are the same as the through-holes 717 of the fourth embodiment. Further, the pad portions 818 are the same as the pad portions 718 of the fourth embodiment. The protrusion pieces 831 to 833 are the same as the protrusion pieces 731 to 733 of the fourth embodiment.

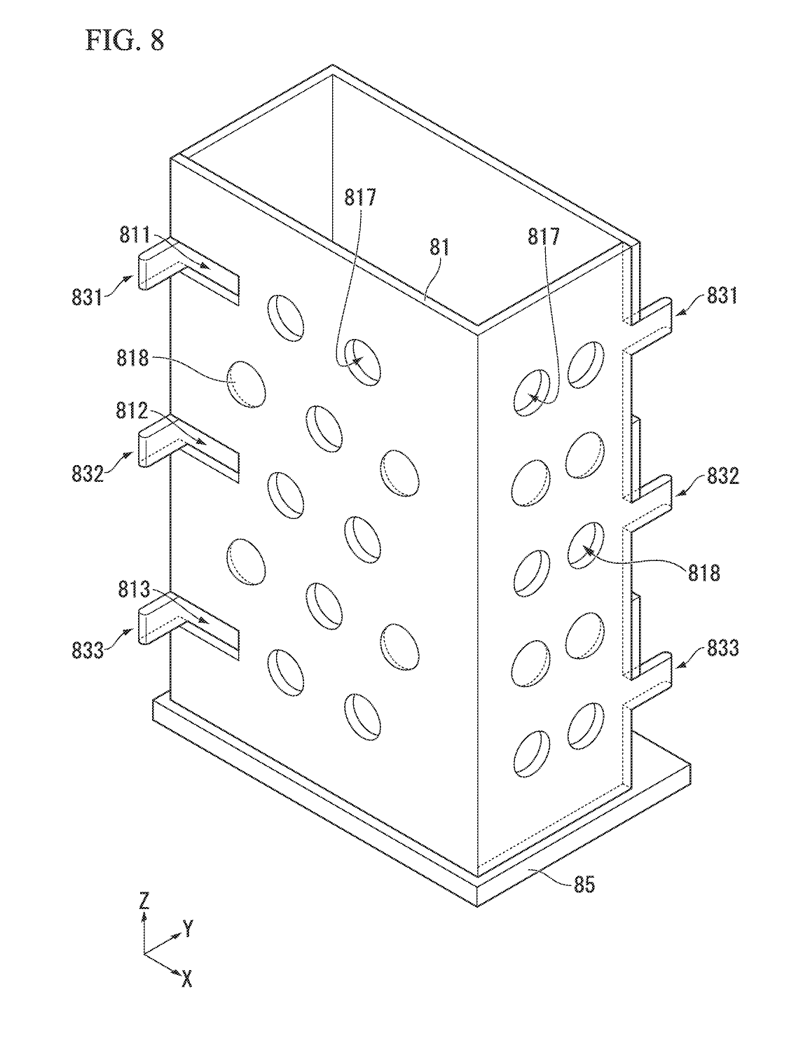

In the fifth embodiment, as shown in FIG. 8, the frame is formed in a manner such that two fourth insulating plates 81 engage with each other around the stacked body 4. That is, the notches 811 to 813 of a first of the fourth insulating plates 81 respectively engage with the protrusion pieces 831 to 833 of a second of the fourth insulating plates 81. Further, the protrusion pieces 831 to 833 of the first of the fourth insulating plates 81 respectively engage with the notches 811 to 813 of the second of the fourth insulating plates 81.

According to the embodiment, because the notches 811 to 813 of the first of the fourth insulating plates 81 and the protrusion pieces 831 to 833 of the second of the fourth insulating plates are movable to engage with each other when the stacked body 4 is expanded due to the charging or the like, the frame is not damaged due to unexpected stress. Further, because the number of components forming a frame decreases, the working efficiency improves and the working cost decreases.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A secondary battery comprising:
a battery case;
a stacked body that is housed inside the battery case and includes a plurality of electrode plates; and
a frame that is arranged between the stacked body and the battery case and formed by engaging a plurality of insulating plates with each other to surround the stacked body in an annular shape,
wherein end surfaces of two of the insulating plates engaging with each other are respectively provided with an engaging portion or an engaged portion, and
wherein the engaging portion formed in the end surface of one of the two insulating plates engages with the engaged portion of the other of the two insulating plates, in order that the stacked body is surrounded in an annular shape by the insulating plates.

2. The secondary battery according to claim 1,
wherein the engaging portion is a protrusion piece that protrudes in the direction perpendicular to a main surface of the one of the two insulating plates, and
wherein the engaged portion is a notch formed by notching at least a part of a main surface of the other of the two insulating plates.

3. The secondary battery according to claim 2,
wherein the frame has a plurality of through-holes.

4. The secondary battery according to claim 1,
wherein the engaging portion is a protrusion piece that protrudes in the direction parallel to a main surface of the one of the two insulating plates, and
wherein the engaged portion is a notch formed in a main surface of the other of the two insulating plates.

5. The secondary battery according to claim 4,
wherein the notch has an opening and a bottom portion corresponding to the opening.

6. The secondary battery according to claim 5,
wherein the frame has a plurality of pad portions to be deformed elastically.

7. The secondary battery according to claim 4,
wherein the frame has a plurality of pad portions to be deformed elastically.

8. A secondary battery comprising:
a battery case;
a stacked body stored in the battery case and including a plurality of electrode plates; and
a frame consisting two insulating plates having an engaging portion or an engaged portion and being arranged between the stacked body and the battery case to surround the stacked body in an annular shape,
wherein the engaging portion formed in one of the two insulating plates engages with the engaged portion formed in the other of the two insulating plates.

9. The secondary battery according to claim 8,
wherein the frame has a plurality of through-holes.

10. The secondary battery according to claim 8,
wherein the engaging portion is a protrusion piece, and
wherein the engaged portion is a notch.

11. The secondary battery according to claim 10,
wherein the notch has an opening and a bottom portion corresponding to the opening.

12. The secondary battery according to claim 8,
wherein the frame has a plurality of pad portions to be deformed elastically.
